(19) United States
(12) Patent Application Publication
(10) Pub. No.: US 2010/0202757 A1
(43) Pub. Date: Aug. 12, 2010

(54) APPARATUS FOR RECORD/PLAYBACK OF VIDEO DATA AND METHOD USED IN SAID APPARATUS

(76) Inventor: Masashi SHIRATORI, Kokubunji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/700,183

(22) Filed: Feb. 4, 2010

(30) Foreign Application Priority Data
Feb. 6, 2009 (JP) 2009-026260
Jan. 26, 2010 (JP) 2010-013785

(51) Int. Cl. H04N 5/91

(52) U.S. Cl. 386/95; 386/E05.003

(57) ABSTRACT

An apparatus for writing video data to a recording medium includes an input unit receiving video data including a first video part and a second video part, a writing unit writing the video data in the recording medium, an operator input unit provided with buttons and generating a first button signal in accordance with operator's operation of pressing ones of the buttons and a second button signal in accordance with operator's operation of pressing at least the other one of the buttons, and a controller generating first and second commands in response to the first and second button signals, respectively, and controls the writing unit in accordance with the first or second command.

### CROSS-REFERENCE TO RELATED APPLICATIONS

This application is based upon and claims the benefit of priority from prior Japanese Patent Applications No. 2009-026260, filed Feb. 6, 2009; and No. 2010-013785, filed Jan. 26, 2010, the entire contents of both of which are incorporated herein by reference.

### BACKGROUND OF THE INVENTION

1. Field of the Invention

This invention relates to an apparatus configured to record video data acquired by means of a camera, for example, in a semiconductor recording medium and play back video data recorded in the semiconductor recording medium and a method used in the apparatus.

2. Description of the Related Art

In a conventional videotape recorder (VTR) apparatus, in order to confirm video images recorded on the tape, a still image (hereinafter referred to as an index image) having a title logo and other program information of a main video image described therein may be recoded before the main video image. Further, in a conventional VTR, an index image may sometimes be recorded before the main video image in order to distinguish a video image recorded on the tape from a video image recorded on another tape. This is useful since the content of the tape can be visually determined by playing back the first portion of the tape.

On the other hand, the index image must not be broadcast since it is not the main video image. However, since the index image and main video image are successively recorded on the same tape, they can be broadcast by performing the same playback process. Therefore, in an emergent broadcasting case, there occurs a problem that an index image will be erroneously broadcast although a schedule is made up to broadcast the main video image.

An apparatus that can easily distinguish a title image file and a captured image file by managing the title image file and captured image file by means of different folders is proposed (for example, see Jpn. Pat. Appln. KOKAI Publication No. 2002-41343 and Jpn. Pat. Appln. KOKAI Publication No. 2004-158943). However, even if the files can be easily distinguished, a measure to cope with a problem that an index image is erroneously broadcast is not described.

### BRIEF SUMMARY OF THE INVENTION

An object of the present invention is to provide an apparatus for record/playback of video data and a method used in said apparatus capable of easy managing of an index image and main video image, and preventing an index image from being erroneously broadcast.

According to an aspect of the present invention, there is provided an apparatus for writing video data to a random-accessibly recording medium, said apparatus comprising: an input unit configured to receive video data including a first video part and a second video part; a writing unit configured to write the video data in the recording medium; an operator input unit provided with buttons, configured to generate a first button signal in accordance with operator's operation of pressing ones of the buttons and a second button signal in accordance with operator's operation of pressing at least the other one of the buttons; and a controller configured to generate first and second commands in response to the first and second button signals, respectively, and configured to control the writing unit so as to store the first video part in a first type file in the recording medium, in accordance with the first command and the second video part in a second type file in the recording medium, in accordance with the second command.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a video data processing apparatus according to one embodiment of this invention.

FIG. 2 is a block diagram showing the functional configuration of the video data processing apparatus of FIG. 1.

FIG. 3 is a flowchart for illustrating the processing operation of a controller when a captured video image is recorded in a built-in recording medium of FIG. 2.

FIG. 4 is a flowchart for illustrating the processing operation of the controller when a video file recorded in the built-in recording medium of FIG. 2 is played back.

FIG. 5 is a block diagram showing another example of the functional configuration of the video data processing apparatus of FIG. 1.

### DETAILED DESCRIPTION OF THE INVENTION

One embodiment of this invention will be described in detail with reference to the accompanying drawings.

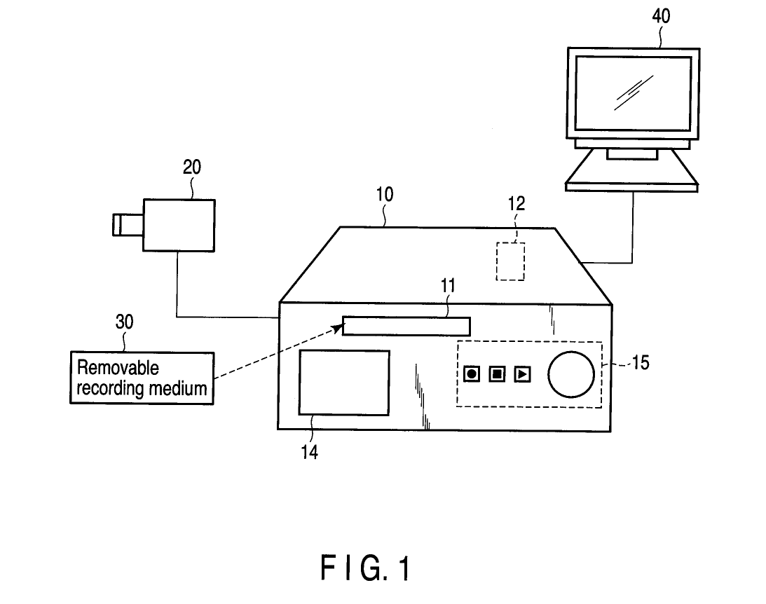

FIG. 1 is a schematic view showing a video data processing apparatus according to one embodiment of this invention. A video data processing apparatus 10 in FIG. 1 is connected to a camera 20. The video data processing apparatus 10 fetches a video image captured by the camera 20. At least one of a removable recording medium 30 and built-in recording medium 12 records the fetched video image. The removable recording medium 30 is inserted via an insertion port 11. The built-in recording medium 12 is a recording medium contained in the apparatus main body.

As the removable recording medium 30 and built-in recording medium 12, for example, a randomly accessible nonvolatile semiconductor memory such as flash memory is used. Flash memory is a rewritable nonvolatile semiconductor memory and has an advantage of a high-speed random access operation. Further, flash memory is excellent in resistance to vibration since, unlike a tape or optical disk drive, it has no moving parts.

A display unit 14 and an operator input unit 15 are provided on the front panel of the main body of the video data processing apparatus 10.

For example, the display unit 14 is configured by a liquid crystal display (LCD). For example, the display unit 14 displays a video file recorded in the removable recording medium 30 or built-in recording medium 12.

The operator input unit 15 comprises a record button, stop button, playback button and dial. The user operates the buttons and dial. The operator input unit 15 accepts execution commands for a recording process and playback process by the user's operation of pressing one of ones of the buttons.

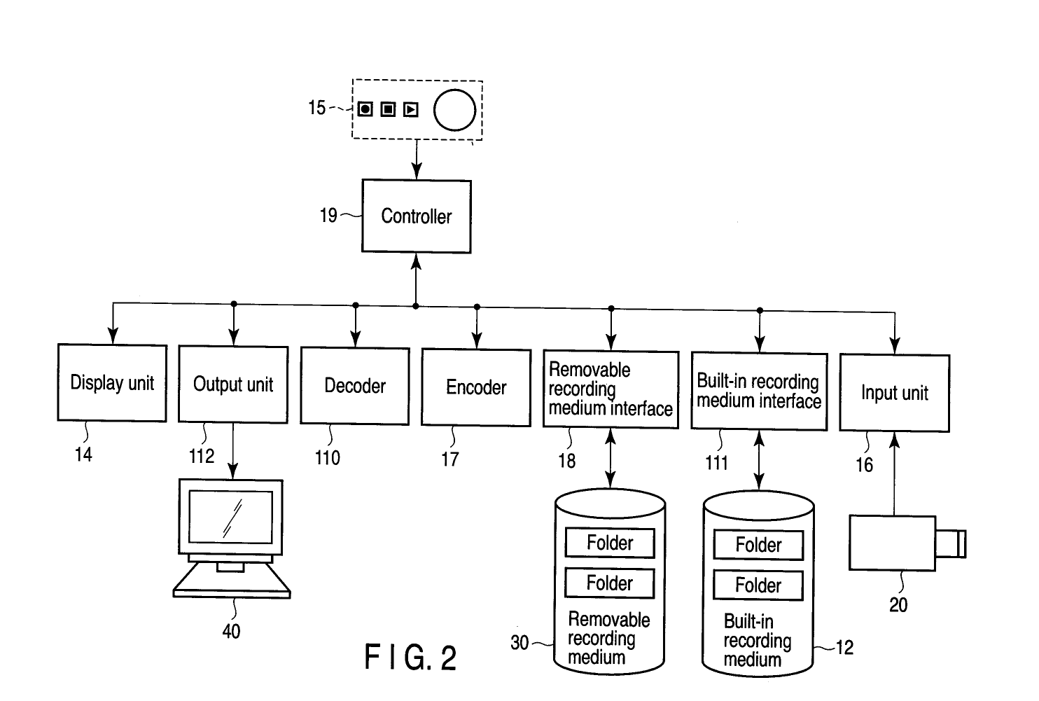

FIG. 2 is a block diagram showing the functional configuration of the video data processing apparatus 10 according to one embodiment of this invention. In the video data processing apparatus 10, an input unit 16 receives a video image captured by the camera 20. An encoder 17 encodes a video image input via the input unit 16 according to a predetermined code.

A removable recording medium interface 18 is connected to the removable recording medium 30. The interface 18 writes a video file encoded by the encoder 17 into the removable recording medium 30 in accordance with a writing command from a controller 19 that will be described later when a captured video image is recorded in the removable recording medium 30. In this case, in the removable recording medium 30, the video file is classified to be stored in a file type referred to as a “folder” (also referred to as a directory or bin). In this embodiment, at least two folders are previously formed. The video file written by means of the interface 18 is set to be stored in one of the two folders in accordance with the writing command from the controller 19.

Further, the interface 18 reads a video file stored in one of the two folders in the removable recording medium 30 in accordance with a reading command from the controller 19 when the video image is played back. The interface 18 outputs the read video file to a decoder 110.

A built-in recording medium interface 111 is connected to the built-in recording medium 12. The interface 111 writes a video file encoded by the encoder 17 into the built-in recording medium 12 in accordance with the writing command from the controller 19 when a captured video image is recorded in the built-in recording medium 12. In this case, at least two folders are previously formed in the built-in recording medium 12. The video file written by means of the interface 111 is set to be stored in one of the two folders in accordance with the writing command from the controller 19.

Further, the interface 111 reads a video file stored in one of the two folders in the built-in recording medium 12 in accordance with the reading command from the controller 19 when the video image is played back. The interface 111 outputs the read video file to the decoder 110.

The decoder 10 decodes a video file read from the recording medium 12 or 30 and outputs the decoded data to the display unit 14 or output unit 112. As a result, the display unit 14 displays the video image. Further, an external monitor 40 receives a video image via the output unit 112 and displays the received video image.

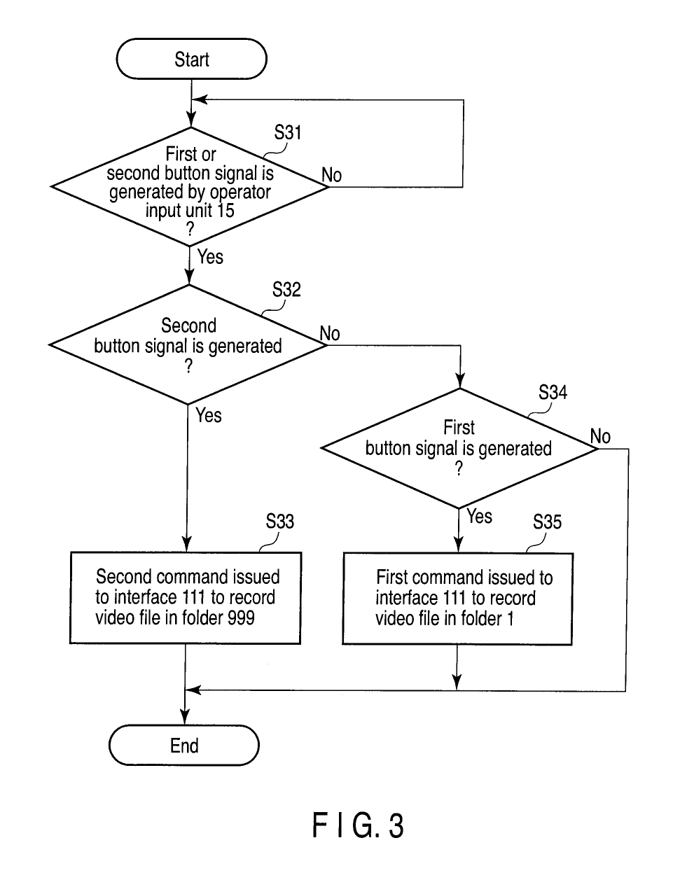

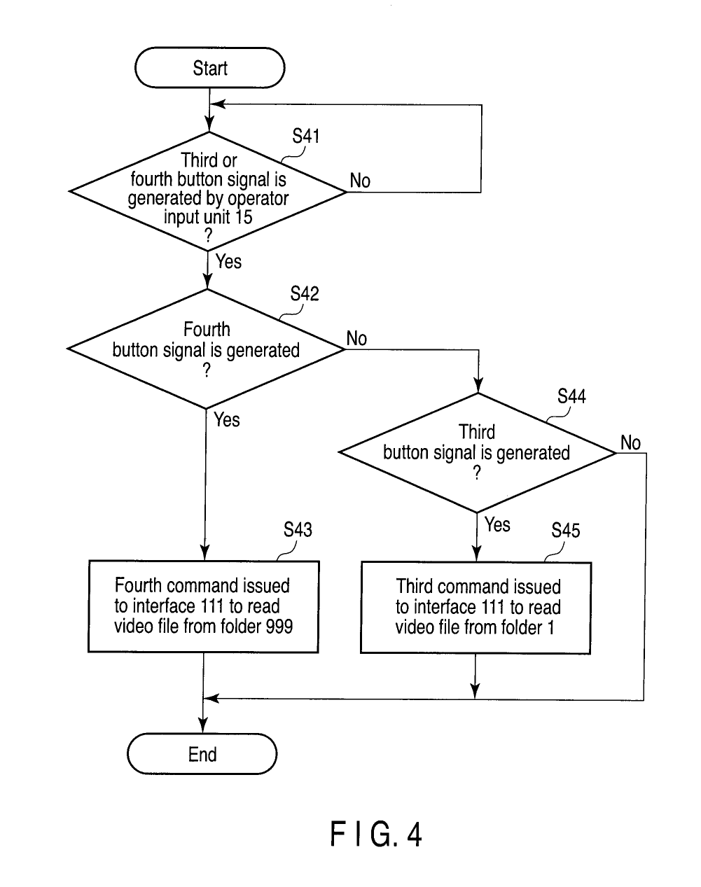

The controller 19 is configured by a central processing unit (CPU) such as a microprocessor. The controller 19 controls the operation of the constituents of the video data processing apparatus 10 in accordance with the execution commands input to the operator input unit 15. The concrete operation is explained with reference to the flowcharts shown in FIGS. 3 and 4. In this case, since the processes for the built-in recording medium 12 and removable recording medium 30 are the same, the process for the built-in recording medium 12 is explained with reference to FIGS. 3 and 4.

FIG. 3 is a flowchart for illustrating the processing operation of the controller 19 when a video image is recorded in the built-in recording medium 12. It is supposed that two folders including a folder 1 and folder 999 are previously formed in the built-in recording medium 12. The folder 1 is an exclusive folder to store a main video image. The folder 999 is an exclusive folder to store an index image. The index image is a still image having a title logo and other program information of the main video image described therein. Further, in the following explanation, when first buttons, i.e. for example the combination of the record button and the playback button of the operator input unit 15, are simultaneously pressed, the operator input unit 15 generates a first button signal, and outputs the first button signal to the controller 19. Further, when second buttons, i.e. for example, the combination of the record button, the playback button and the stop button of the operator input unit 15, are simultaneously pressed, the operator input unit 15 generates a second button signal, and outputs the second button signal to the controller 19.

First, the controller 19 determines whether or not the first or second button signal is generated by the operator input unit 15 (step 31). If the first or second button signal is generated by the operator input unit 15 (YES in step 31), the controller 19 determines whether or not the second button signal is generated (step 32). If the second button signal is generated (YES in step 32), the controller 19 issues a second command to the interface 111 (step 33). The interface 111 records a video file in the recording medium 12 and cause the video file to be stored in the folder 999 of the recording medium 12 in response to the second command. Then the controller 19 ends the process.

If the second button signal is not generated by the operator input unit 15 (NO in step 32), the controller 19 determines whether or not the first button signal is generated (step 34). If the first button signal is generated (YES in step 34), the controller 19 issues a first command to the interface 111 (step 35). The interface 111 records a video file to the recording medium 12 and cause the video file to be stored in the folder 1 of the recording medium 12 in response to the second command. Then the controller 19 ends the process. On determining that the first button signal is not generated by the operator input unit 15 (NO in step 34), the controller 19 ends the process.

As a result, a video image recorded by pressing the second buttons is recorded as a file 001 stored in the folder 999 which is used for storing the index image. Further, a video image recorded by pressing the first buttons is recorded as a file 001 stored in the folder 1 which is used for storing the main video image.

FIG. 4 is a flowchart for illustrating the processing operation of the controller 19 when a video file recorded in the built-in recording medium 12 is played back. In the following explanation, when a third button, i.e. for example the playback button of the operator input unit 15, is pressed, the operator input unit 15 generates a third button signal, and outputs the third button signal to the controller 19. Further, when fourth buttons, i.e. for example the combination of the playback button and the stop button of the operator input unit 15, are simultaneously pressed, the operator input unit 15 generates a fourth button signal, and outputs the fourth button signal to the controller 19.

First, the controller 19 determines whether or not the third or fourth button signal is generated by the operator input unit 15 (step 41). If the third or fourth button signal is generated by the operator input unit 15 (YES in step 41), the controller 19 determines whether or not the fourth button signal is generated (step 42). If the fourth button signal is generated (YES in step 42), the controller 19 issues a fourth command to the interface 111 (step 43). The interface 111 reads a video file stored in the folder 999 of the recording medium 12 in response to the fourth command. Then the controller 19 ends the process.

If the fourth button signal is not generated by the operator input unit 15 (NO in step 42), the controller 19 determines whether or not the third button signal is generated (step 44). If the third button signal is generated (YES in step 44), the controller 19 issues a third command to the interface 111 (step 45). The interface 111 reads a video file stored in the folder 1 of the recording medium 12 in response to the third command. Then the controller 19 ends the process. On determining that the third button signal is not generated by the operator input unit 15 (NO in step 44), the controller 19 ends the process.

As a result, when the fourth buttons are pressed, a file 001 stored in the folder 999 is read as the index image. The index image is displayed on the display unit 14 or external monitor 40. Further, when the third button is pressed, a file 001 stored in the folder 1 is read as the main video image. The main video image is displayed on the display unit 14 or external monitor 40.

As described above, in the above embodiment, the video data processing apparatus 10 records a captured video image in the exclusive folder to store the main video image when the first buttons of the operator input unit 15 are pressed. Further, when the second buttons of the operator input unit 15 are pressed, it records the captured video image in the exclusive folder to store the index image. As a result, the video data processing apparatus 10 can record the video file in the folder for storing the index image only when the second buttons are pressed. Further, the video data processing apparatus 10 can record an index image without performing a complicated operation if a still image having the title logo and other program information of the main video image described therein is captured by pressing the second buttons.

Further, in the above embodiment, the video data processing apparatus 10 reads a video file from the exclusive folder storing the main video image if the playback button, i.e. the third button, of the operator input unit 15 is pressed. On the other hand, if the fourth buttons of the operator input unit 15 is pressed, it reads a video file from the exclusive folder storing the index image. As a result, the video data processing apparatus 10 can read a video file from the folder storing the index image only when the fourth buttons are pressed. That is, since the operation for play back the index image is different from that for play back the main video image, it becomes possible to prevent the index image from being erroneously played back instead of the main video image.

Therefore, the video data processing apparatus and video data record/playback method according to this invention can easily manage an index image and main video image, and prevent an index image from being erroneously broadcast.

This invention is not limited to this embodiment. For example, in the above embodiment, the two folders in the built-in recording medium 12 are provided as the folder 1 and folder 999, but the numbers of the folders are not limited to the above example. In this embodiment, the reason why the number of the index image folder is set to “999” is that the folder 999 is a folder which is relatively less frequently used in general. Further, it is because a difference between the number of the folder and the number of the folder 1 that is the main video image folder is made clearer.

In addition, in the above embodiment, a case wherein the second buttons corresponds to the combination of the record button, the playback button, and the stop button, and the second button signal is issued to the controller 19 if the second buttons are simultaneously pressed is explained. However, the second buttons are not limited to this example. Likewise, the fourth buttons are not limited to the operation example performed when the playback button and the stop button are simultaneously pressed.

Further, in the above embodiment, an example in which the operator input unit 15 has the record button, the playback button and the stop button is explained, but the number of buttons of the operator input unit 15 according to this invention is not limited to three. For example, it is possible to provide an exclusive button for index image recording on the operator input unit 15. The operator input unit 15 generates the second button signal in accordance with the user's operation of pressing the exclusive button. Further, it is possible to provide an exclusive button for index image playback on the operator input unit 15. The operator input unit 15 generates the fourth button signal in accordance with the user's operation of pressing the exclusive button.

In the above embodiment, a case wherein one of the video files is played back when one video file for the index image and one video file for the main video image are recorded in the built-in recording medium 12 is explained. However, it is not necessary to set the number of video files recorded in the built-in recording medium 12 to one for each of the index image and main video image. For example, this invention can be similarly embodied even if plural video files for index images and plural video files for main video images are recorded in each of the recording media 12, 30. In this case, a plurality of thumbnail images that are representative images of the main video images are displayed on the display unit 14 or external monitor 40. Then, one of the plural thumbnail images may be selected to play back the index image or main video image. If the thumbnail image can be thus selected to display the index image, it becomes effective when the plural thumbnail images displayed on the display unit 14 or external monitor 40 are the same.

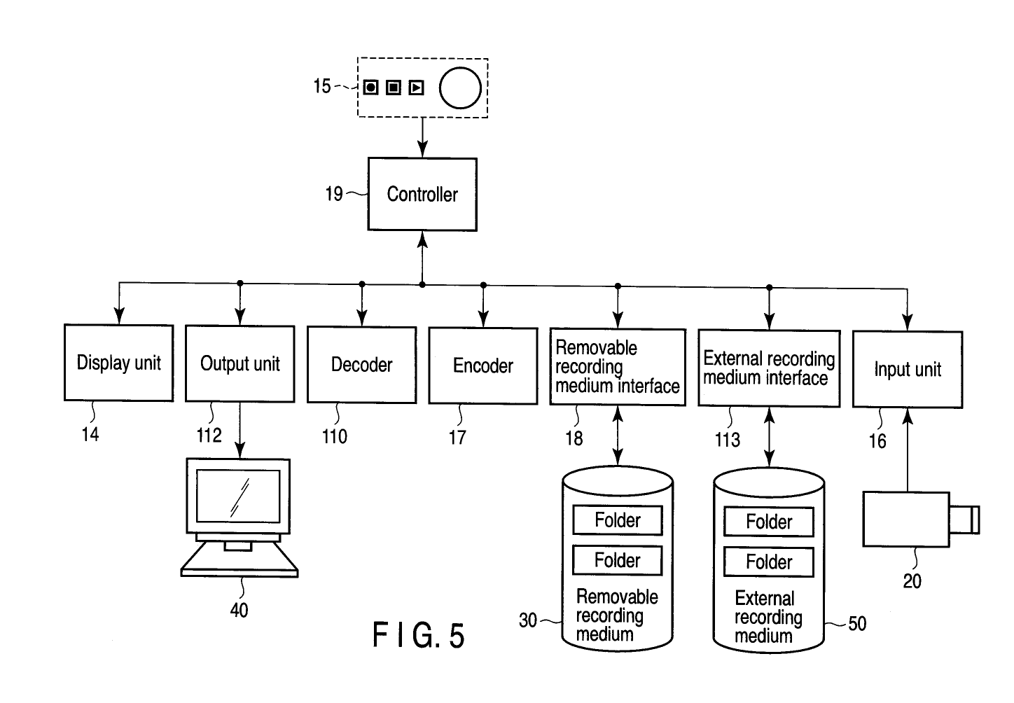

Further, in the above embodiment, an example in which the video data processing apparatus 10 comprises the built-in recording medium 12 in the internal portion of the apparatus is explained. However, the video data processing apparatus 10 does not necessarily comprise the built-in recording medium 12. For example, this invention can be similarly embodied when the video data processing apparatus 10 comprises an external recording medium interface 113 and it is connected to an external recording medium 50 via a USB cable or the like as shown in FIG. 5.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for writing video data to a random-accessibly recording medium, said apparatus comprising:
an input unit configured to receive video data including a first video part and a second video part;
a writing unit configured to write the video data in the recording medium;
an operator input unit provided with buttons, configured to generate a first button signal in accordance with operator's operation of pressing ones of the buttons and a second button signal in accordance with operator's operation of pressing at least the other one of the buttons; and
a controller configured to generate first and second commands in response to the first and second button signals, respectively, and configured to control the writing unit so as to store the first video part in a first type file in the recording medium, in accordance with the first command and the second video part in a second type file in the recording medium, in accordance with the second command.

2. The apparatus according to claim 1, wherein the buttons include first to fourth buttons, the first button corresponds to the ones of buttons, the second button corresponds to the at least the other one of the buttons.

3. The apparatus according to claim 2, further comprising a reading unit that reads video data from the recording medium,
wherein the operator input unit generates a third button signal in accordance with operator's operation of pressing the third button and a fourth button signal in accordance with operator's operation of pressing the fourth button,
the controller generates third and fourth commands in response to the third and fourth button signals, respectively, and controls the reading unit so as to read the first video part from the first type file in the recording medium, in accordance with the third command and to read the second video part from the second type file in the recording medium in accordance with the fourth command.

4. The apparatus according to claim 1, wherein
the first video part corresponds to a main part of the video data,
the second video part corresponds to a index part of the video data.

5. The apparatus according to claim 2, wherein the second button correspond to a combination of a record button, a playback button, and a stop button.

6. The apparatus according to claim 2, wherein the second button corresponds to an exclusive button used for recording the index part.

7. The apparatus according to claim 3, wherein the fourth button corresponds to a combination of a playback button and stop button.

8. The apparatus according to claim 3, wherein the fourth button corresponds to an exclusive button used for playing back the index part.

9. A method used in an apparatus for processing video data which is random-accessibly recorded on a recording medium, the apparatus comprising an input unit which receives video data including a first video part and a second video part, a writing unit which writes the video data in the recording medium, and an operator input unit provided with buttons, said method comprising:
generating a first button signal in accordance with operator's operation of pressing one of the buttons and a second button signal in accordance with operator's operation of pressing at least the other one of the buttons;
generating first and second commands in response to the first and second button signals, respectively; and
controlling the writing unit so as to store the first video part in a first type file in the recording medium, in accordance with the first command and the second video part in a second type file in the recording medium, in accordance with the second command.

10. The method according to claim 9, wherein the buttons include first to fourth buttons, the first button corresponds to the one of buttons, the second button corresponds to the at least the other one of the buttons.

11. The method according to claim 10, the apparatus further comprising a reading unit that reads video data from the recording medium, said method further comprising:
generating a third button signal in accordance with operator's operation of pressing the third button and a fourth button signal in accordance with operator's operation of pressing the fourth button; and
generating third and fourth commands in response to the third and fourth button signals, respectively,
controlling the reading unit so as to read the first video part from the first type file in the recording medium, in accordance with the third command and to read the second video part from the second type file in the recording medium in accordance with the fourth command.
